(19) United States
(12) Patent Application Publication
(10) Pub. No.: US 2025/0302007 A1
(43) Pub. Date: Oct. 2, 2025

(54) Device for Keeping the Mouth of a Pet Open to Enable Toothbrushing

(71) Applicant: Peter Makarious, Markham (CA)

(72) Inventor: Peter Makarious, Markham (CA)

(21) Appl. No.: 18/506,566

(22) Filed: Nov. 10, 2023

Related U.S. Application Data
(60) Provisional application No. 63/424,549, filed on Nov. 11, 2022.

(51) Int. Cl. A01K 15/02

(52) U.S. Cl. CPC A01K 15/026

(57) ABSTRACT

While there are a lot of upsides to having a pet, owning a pet also comes with responsibilities. One of the primary responsibilities being to take care of the pet's health including practicing good oral hygiene. If a pet's teeth are not brushed regularly, plaque can begin to build up, which may result in bad breath, gum disease, and tooth decay (cavities). If the tooth decay is not treated, it can lead to painful infections and even life-threatening conditions if the infection spreads through the pet's body. It can be difficult to brush a pet's teeth at home because the pet does not like having its teeth brushed. A device for keeping the mouth of a pet open to enable tooth brushing is disclosed, the device comprising: a toy/mouth portion having an external surface; a strap portion; and a fastening means for adjusting the tautness of the strap portion.

### CROSS-REFERENCE TO RELATED APPLICATIONS

I hereby claim benefit under Title 35, United States Code, Section 119(e) of U.S. provisional patent application Ser. No. 63/424,549 filed Nov. 11, 2022. The 63/424,549 application is currently pending. The 63/424,549 application is hereby incorporated by reference into this application.

### STATEMENT REGARDING FEDERALLY SPONSORED RESEARCH OR DEVELOPMENT

Not applicable to this application.

### THE NAMES OF THE PARTIES TO A JOINT RESEARCH AGREEMENT

Not applicable to this application.

### BACKGROUND OF INVENTION

### Field of Invention

More and more people are getting pets. Dogs are particularly popular as pets because they are affectionate and make great companions. There are many benefits to owning a dog, including: feeling less alone, having reduced stress and anxiety, and feeling happier. In addition, taking a dog for a walk or run is a great form of exercise. While there are a lot of upsides to having a dog, owning a dog also comes with responsibilities.

One of the primary responsibilities being to take care of the dog's health including practicing good oral hygiene. If a dog's teeth are not brushed regularly, plaque can begin to build up, which may result in bad breath, gum disease, and tooth decay (cavities). If the tooth decay is not treated, it can lead to painful infections and even life-threatening conditions if the infection spreads throughout the dog's body.

It can be difficult to brush a dog's teeth at home, since, by nature, a dog does not like having its teeth brushed. In fact, the dog may hate getting their teeth brushed. In response to having their teeth brushed, a dog may shake their head or move their body to avoid having their teeth brushed. Worse, a dog may attempt to bite the fingers of the person brushing its teeth to stop the teeth from being brushed. However, as discussed above, abstaining from regularly brushing the dog's teeth is not a good solution to avoiding finger bites as it can result in the dog developing bad breath, gum disease, and tooth decay (cavities). Therefore, regular teeth cleaning is a non-negotiable component of a proactive pet care routine.

### Description of Related Art

One option to regularly clean a dog's teeth is to use the Bite Block™ designed and developed by sparkinnovations. The Bite Block™ functions as a barrier to protect an owner's fingers from getting bit while brushing a dog's teeth. However, the Bite Block™ is not also a dog toy and it will not stay in the dog's mouth as desired by pet owners because the dog will constantly move their head forcefully to avoid getting their teeth brushed.

If a dog's teeth have not been brushed for a long time and there is a lot of plaque build up, it may be preferable to take the dog to a veterinarian or veterinarian dentist to have the dog's teeth professionally cleaned. A professional cleaning typically involves the use of anesthesia to temporarily put the dog to sleep to make it easier for the veterinarian or veterinarian dentist to perform the cleaning. However, using anesthesia to temporarily put a dog to sleep can be a traumatizing experience for the dog, lead to confusion for the dog when they awake, be very expensive for the dog owner, and not ideal for families with young children, who may be frightened by having their dog temporarily put to sleep.

A dog owner may want to keep their dog's mouth open for other reasons as well.

Accordingly, there remains a need for improvements in the art in which a dog owner's fingers are protected from dog bites, the dog's teeth are regularly brushed in an easier manner, and/or the dog enjoys having their teeth brushed.

### BRIEF SUMMARY OF THE INVENTION

The device of the present invention can be used to help a pet owner brush their pet's teeth without getting bit and without harming/scaring their pet. Preferably, the pet is a dog. The device of the present invention may also be used by teething puppies to chew on. The device of the present invention may also be used as a safety device so that dog technicians are not bitten when cutting, trimming, grinding, or providing spa treatments to dogs. The device of the present invention may also be used in the entertainment industry in combination with a green screen to keep a dog's mouth open with the device being edited out after filming has been completed.

In an embodiment of the present invention, there is provided a device for keeping the mouth of a pet open to enable tooth brushing, the device comprising: a toy/mouth portion having an external surface; a strap portion; and a fastening means for adjusting the tautness of the strap portion.

The fastening means for adjusting the tautness of the strap portion can be a cord lock wherein a plastic cord lock attaches to drawstrings and tightens without the use of knots upon pulling of a clip.

Preferably, the strap portion further comprises a first end attached to a first point on the external surface of the toy/mouth portion and a second end attached to a second point on the external surface of the toy/mouth portion, wherein the second point on the external surface of the toy/mouth portion is positioned substantially opposite to the first point on the external of the first end of the toy/mouth portion.

Preferably, the toy/mouth portion further comprises a central bore therethrough and wherein the strap portion passes through the central bore.

Preferably, the strap portion can be removed from the toy/mouth portion.

Preferably, the toy/mouth portion has the shape of a sphere, cylinder, or ovoid. In addition, the toy/mouth portion can take on the shape of well-known objects, such as a dumbbell or a dog bone.

Preferably, the toy/mouth portion has the shape of a bone or a wooden stick.

Preferably, the toy/mouth portion has the shape of a dog, cat, squirrel, bunny, or bird.

Preferably, the external surface of the toy/mouth portion comprises a plurality of protrusions.

Preferably, the toy/mouth portion and the strap portion comprise at least one of rubber, silicone, plastic, textile, wood, stainless steel, metal, raw material, recycled material (e.g., cardboard), aluminum, silver and gold.

Preferably, the toy/mouth portion comprises a resilient material.

Preferably, the resilient material is rubber.

Preferably, the fastening means comprises an adjustable clip.

Preferably, the pet is a dog.

In another embodiment of the present invention, there is provided a method for brushing the teeth of a pet, the method comprising the steps of: a) providing a device to a pet for keeping the mouth of the pet open to enable tooth brushing, the device comprising: a toy/mouth portion having an external surface; a strap portion; and a fastening means for adjusting the tautness of the strap portion; b) placing the toy/mouth portion of the device into the pet's mouth; c) engaging the fastening means so that toy/mouth portion of the device is positioned at the back of the pet's mouth; and d) brushing the pet's teeth.

Preferably, the method further comprising after step b), b-i) moving the strap so that the fastening means is positioned behind the pet's head, below the level of the pet's ears.

Preferably, the method further comprising after step d), e) loosening locking means.

Preferably, the method further comprising after step e), f) removing the device from the dog's mouth.

Preferably, the toy/mouth portion of the invention can be separated from the strap portion to be used as a chew toy by the pet which in effect allows regular teeth cleanings to coincide with the pet's playtime.

Preferably, the fastening means is a cord lock.

Preferably, the pet is a dog.

Advantageously, the device of the present invention keeps a pet's mouth fully open so that brushing the pet's teeth is easier, even if the pet constantly moves their head; helps to avoid hospital bills and anesthesia; is customer friendly and easy to use; and acts as both a bite blocker and a toy, so that the pet becomes familiar with the device and does not fear it.

Other aspects and features according to the present application will become apparent to those ordinarily skilled in the art upon review of the following description of embodiments of the invention in conjunction with the accompanying figures.

### BRIEF DESCRIPTION OF THE SEVERAL VIEWS OF THE DRAWING

The principles of the invention may better be understood with reference to the accompanying figures provided by way of illustration of an exemplary embodiment, or embodiments, incorporating principles and aspects of the present invention, and in which:

FIG. 1 is a perspective view of a first embodiment of the invention;

FIG. 2 is a perspective view of a second embodiment of the invention; and

FIG. 3 is a side view of the first embodiment of the invention in a pet's mouth.

FIG. 4 is a cross-sectional view of the first embodiment of the invention with a central bore going therethrough

### DETAILED DESCRIPTION OF THE INVENTION

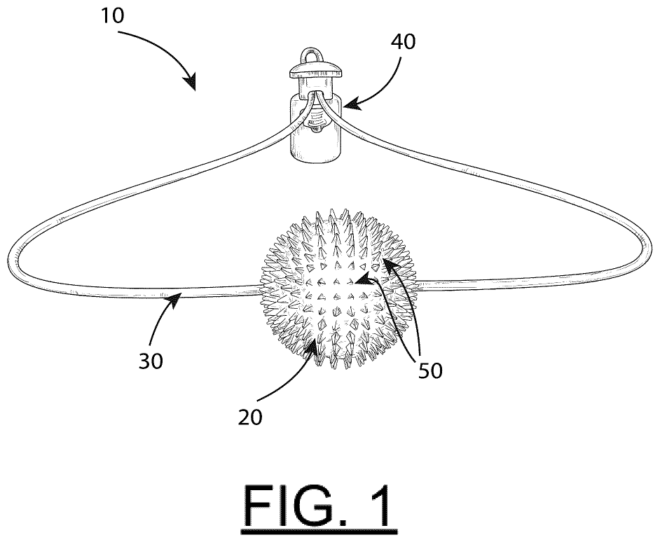

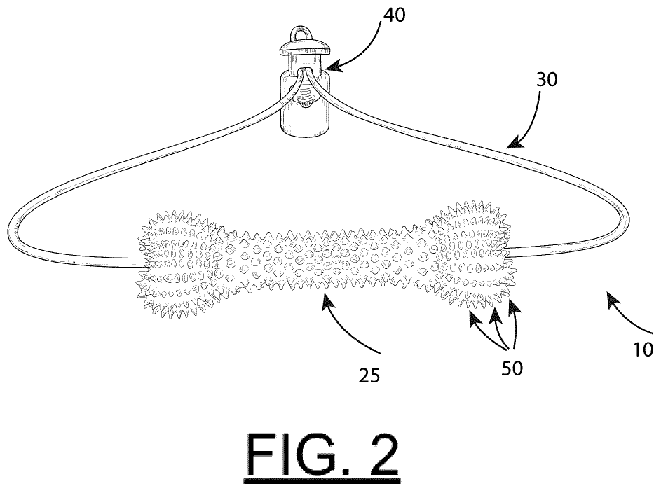

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and, in some instances, proportions may have been exaggerated in order more clearly to depict certain features of the invention. Referring to FIGS. 1 and 2, a device 10 for keeping the mouth of a pet open to enable tooth brushing is shown. The device 10 comprises a toy/mouth portion (20 in FIG. 1; 25 in FIG. 2) having an external surface, a strap portion 30, and a fastening means 40 for adjusting the tautness of the strap portion 30. Preferably, the fastening means 40 is an adjustable clip. Preferably, the toy/mouth portion (20 in FIG. 1; 25 in FIG. 2) is shaped so as to be desirable as a toy to a pet. In one embodiment, the toy/mouth portion 20 as shown FIG. 1 is shaped like a ball. In another embodiment, the toy/mouth portion 25 as shown in FIG. 2 is shaped like a bone. In other embodiments, the toy/mouth portion has the shape of a dog, cat, squirrel, bunny, or bird. The possibilities are endless. Preferably, the external surface of the toy/mouth portion (20 in FIG. 1; 25 in FIG. 2) comprises a plurality of protrusions 50. Preferably, the protrusions have a conical shape. Protrusions 50 provide the device 10 more texture and therefore more enjoyable for a pet to play with.

Preferably, the device 10 is made of a resilient material. Preferably, the resilient material is rubber. However, other materials such as silicone, plastic, textile, wood, stainless steel, metal, raw material, recycled material (e.g., cardboard), aluminum, silver or gold could be used. Preferably, the device 10 is made of rubber and is produced by molding. However, other manufacturing methods known to the person of skill in the art could also be used, for example, casting, machining, plating, forming, additive manufacturing and 3D printing.

In one embodiment, the strap portion 30 comprises a first end attached to a first point on the external surface of the toy/mouth portion 20 and a second end attached to a second point on the external surface of the toy/mouth portion 20, wherein the second point on the external surface of the toy/mouth portion is positioned substantially opposite to the first point on the external of the first end and the toy/mouth portion. Preferably, the toy-mouth portion 20 and the strap 30 comprise a single piece. In an alternate embodiment, the toy/mouth portion 20 further comprises a central bore therethrough and the strap portion 30 passes through the central bore. In this embodiment, the strap 30 is a separate piece from the toy-mouth portion 20. In such an embodiment, the strap 30 may have a break in it to assist with device assembly. In such an embodiment, a connecting means (not shown) is used to connect the two ends of the strap 30 together. Preferably, the connecting means comprises one of a twist to lock mechanism (for example, having, but not being limited to, a “T”, “U” or “V” shape), a screw to lock mechanism, a locking mechanism comprising a ball, and a pinch-to-lock mechanism.

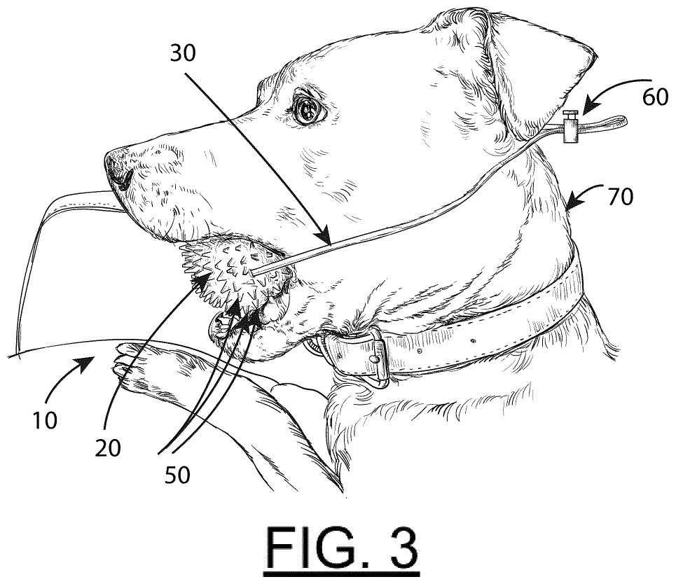

Referring to FIG. 3, a pet 70 is shown with the toy/mouth portion 20 of the device 10 in its mouth. Preferably, the pet 70 is a dog. Preferably, the fastening means 60 is a cord lock. Preferably, the fastening means 60 is removable from strap 30. The strap 30 is taut and the fastening means 60 is positioned behind the head of the pet 70. The pet 70 as shown is ready for its teeth to be brushed. In order to get the device 10 into this position, first, the device 10 is provided to the pet 70. The pet 70 starts playing with device 10 and places the toy/mouth portion 20 into its mouth. In cases where the pet 70 does not start playing with the device 10, the device 10 may need to be manually placed into the mouth of the pet 70. In the embodiment where the fastening means 60 is removable from strap 30, second, the fastening means 60 is placed onto strap 30. The fastening means 60 is then pulled to the back of the pet's 70 head to lock the toy/mouth portion 20 at the back of the pet's 70 mouth/teeth to help keep the pet's 70 mouth open. With the toy-mouth portion 20 of the device positioned at the back of the pet's 70 mouth, the fastening means 60 is engaged, behind the pet's head and below the level of the pet's 70 ears to maintain the device 10 at the back of the pet's 70 mouth. The pet's teeth can then be brushed thoroughly without any discomfort to the pet. Once the brushing has been completed, the fastening means 60 is moved so that the strap 30 becomes loosened. The pet 70 can then either continue playing with the device 10 or the device 10 can be removed from the pet's mouth 70 by the pet owner. An advantage of the fastening means 60 being removable from the strap 30 is that after the pet's 70 teeth have been brushed, the fastening means 60 can be removed from the strap 30 so that the pet 70 can safely play with the device 10. This is true because the fastening means 60 may be a choking hazard because it is small and may contain plastic and/or metal.

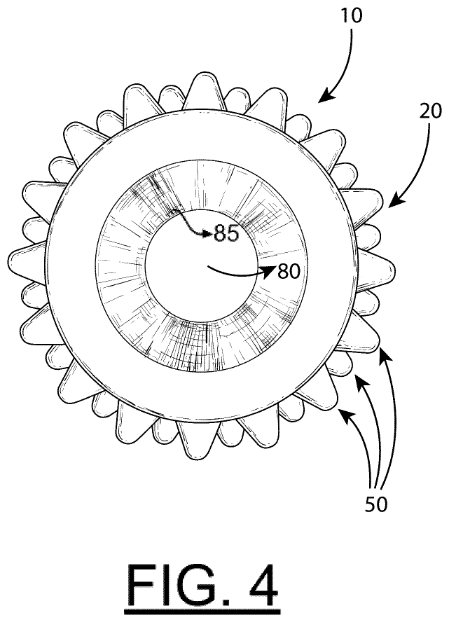

FIG. 4 depicts the toy/mouth portion of the device with a central bore 80 going therethrough, and shading 85 to show the central bore extending from a first circular opening on one end of the toy/mouth portion to a second circular opening on a substantially opposite end of the toy/mouth portion, maintaining a uniform diameter throughout such that both the first and second circular openings have substantially equal diameters. The central bore 80 therethrough is used to allow for a strap portion to pass through said toy/mouth portion instead of attaching to points on substantially opposite ends of said toy/mouth portion, thereby allowing the strap portion to remain as one uninterrupted loop. The cylindrical shape of the central bore 80 is also capable of accepting for insertion a cylindrical container used for storing enhancements to the tooth brushing experience for pets. Said enhancement can range from pet supplements to toothpaste. When the toy/mouth portion is chewed on by the pet 70 in FIG. 3, pressure is applied onto the toy/mouth portion, and the diameter of the central bore 80 decreases as the pressure of the pet's 70 bite increases. The decrease in diameter of the central bore 80 in turn results in pressure increasingly being applied against the cylindrical container containing the enhancements, which results in the contents of the cylindrical container being dispensed through a dispensing means. In the best mode known to the inventor at the time of filing, such means would comprise a multiplicity of tiny pores scattered along the outer surface of said cylindrical container. The diameter of the cylindrical container is less than that of central bore 80, allowing it to be inserted and removed therefrom with ease. Pressure applied by pet 70's chewing action will be the driving force by which the contents of said container will cross through the pores and into the pet's 70 mouth via central bore 80.

### ADDITIONAL INFORMATION

The following non-exhaustive list of lock mechanisms considered by the inventor throughout the inventive process for this invention, and is not intended to be limiting:
Ball lock: uses a deformable sphere that expands inside a sphere-shaped groove, this expansion locks the sphere in place. Must be inserted using force, and also removed by force (enough force to deform the sphere).
V lock: a pointed lock that enters a V shaped groove, small latches in the lock expand and lock themselves in the groove. The lock is inserted by force, and it must be removed by bending the latches inward until they no longer engage with the toy.
U lock: Very similar to V locks but the ending of the lock and the groove is more rounded. For inserting and removing this lock, bend the latches inward first and then engage or disengage the lock.
Splined lock: Similar to a ballpoint pen click mechanism, this lock uses a spline that must be inserted and then rotated into a locked place with a small tuck, a small spring inside the lock will help in keeping the spline in a lock position. To remove, press the lock to move away from the locked position and rotate to have a free release.
Threaded: using a bolt or a screw just rotate the screw in the threaded hole to engage and disengage the lock.
T shape lock: A flat flange Shaped like a T. Inserts into a grove and spins 90° to lock into place due to the geometry of the lock.
X lock: Similar to the T lock. It transposes another T shape lock perpendicular to the original to create an X shape latch. It spins 45° to lock into place due to geometry.
Slide in Latch lock: this lock slides in geometrically and mimics the shape of the toy slightly.
Push pin lock: This lock uses a mechanism similar to push pins of intel CPU cooler fans. In which a dowel expands two plastic extrusions inside the similar shaped groove in the toy therefore locking it in place. The dowel is secured in place by two stoppers that will move out of place by a simple twist.
Slider lock: similar to the pin design you requested this lock consists of four slider parts that meet in the middle locking a circular extrusion in place.
Spin lock: This lock consists of two rotating parts that prevent a circular extrusion for moving out of a cavity.
Circular latch lock: similar to the slide in latch. This lock uses geometry to lock into place and the lock will fit the shape of the toy.
Bag lock: A common type of union usually used in backpacks and other apparel. It resembles a trident where the outer pegs deform and lock themselves in grooves on an opposite rectangular piece.
Car belt lock: A type of lock commonly used in car seatbelts. Consists of a spring-loaded latch that moves a peg forward and is released by the press of a button. The peg locks into place with a hole in the opposite piece's latch.
Bolt and Nut: Having a bolt in the toy will be able to attach a nut with the strap connected.
Hook: A curved extrusion that will hold a rectangular ring that is attached to the strap.
Pinch lock: similar to a bag lock of previous versions this lock uses the deformation of the plastic to have extrusions lock in place in a groove of the toy.
Reverse Circular Latch: this lock works by having a circular extrusion inserted in a circular hole and slide forwards until the geometry prevents the lock from escaping.
6-point star/flower lock: An extrusion in the shape of a 6-point star or a flower enters a hole and is rotated 30° to be kept in place.
Swing lock: a circular part is inserted sideways to a similar groove to be locked in place; this type of lock is commonly used in watches.
Guitar T-screw: as the common guitar strap that uses a sort of T lock and a quarter turn to stay in place, this lock works in similar fashion.
Nub lock: Also similar to how guitars attach their straps, this lock uses a nub and a strap with a cut out. The cut out expands the strap enough to make it past the nub and stay in place.
Pin lock: the locks by having pins that are inserted linearly that keep a circular extrusion in place.
Star lock: An extrusion in the shape of a star enters a hole and is rotated by 36° to be kept in place.

I claim:

1. A device for keeping the mouth of a pet open to enable tooth brushing, the device comprising:
a toy/mouth portion having an external surface;
a strap portion; and
a fastening means for adjusting the tautness of the strap portion.

2. The device according to claim 1, wherein the strap portion further comprises a first end attached to a first point on the external surface of the toy/mouth portion and a second end attached to a second point on the external surface of the toy/mouth portion, wherein the second point on the external surface of the toy/mouth portion is positioned substantially opposite to the first point on the external of the first end of the toy/mouth portion.

3. The device according to claim 1, wherein the toy/mouth portion further comprises a central bore therethrough and wherein the strap portion passes through the central bore.

4. The device according to claim 1, wherein the toy/mouth portion further comprises a central bore therethrough which can accept for insertion a cylindrically-shaped container within which enhancements to the toothbrushing experience for the pet are contained.

5. The device according to claim 1, wherein the toy/mouth portion has the shape of a sphere, cylinder, or ovoid.

6. The device according to claim 1, wherein the toy/mouth portion has the shape of a bone or a dumbbell.

7. The device according to claim 1, wherein the toy/mouth portion has the shape of a dog, cat, squirrel, bunny, or bird.

8. The device according to claim 1, wherein the external surface of the toy/mouth portion comprises a plurality of protrusions.

9. The device according to claim 1, wherein the toy mouth portion and the strap portion comprise at least one of rubber, silicone, plastic, textile, wood, stainless steel, metal, raw material, recycled material (e.g., cardboard), aluminum, silver, and gold.

10. The device according to claim 1, wherein the toy/mouth portion comprises a resilient material.

11. The device according to claim 9, wherein the resilient material is rubber.

12. The device according to claim 1, wherein the fastening means comprises a cord lock.

13. The device according to claim 1, wherein the pet is a dog.

14. A method for brushing the teeth of a pet, the method comprising the steps of:
a) providing a device to a pet for keeping the mouth of the pet open to enable tooth brushing, the device comprising:
a toy/mouth portion having an external surface;
a strap portion; and
a fastening means for adjusting the tautness of the strap portion;
b) placing the toy/mouth portion of the device into the pet's mouth;
c) engaging the fastening means so that toy/mouth portion of the device is positioned at the back of the pet's mouth; and
d) brushing the pet's teeth.

15. The method according to claim 14, further comprising after step b),
b-i) moving the strap so that the fastening means is positioned behind the pet's head, below the level of the pet's ears.

16. The method according to claim 14, further comprising after step d),
e) loosening locking means.

17. The method according to claim 14, further comprising after step e),
f) removing the device from the dog's mouth.

18. The method according to claim 14, further comprising after step f),
g) removing the strap portion from the toy/mouth portion and giving the toy/mouth portion to said pet as a chew toy.

19. The method according to claim 14, wherein the fastening means comprises a cord lock.

20. The method of claim 14, wherein the pet is a dog.
